(19) United States
(12) Patent Application Publication
(10) Pub. No.: US 2003/0231268 A1
(43) Pub. Date: Dec. 18, 2003

(54) Transmission-reflection switch liquid crystal display

(76) Inventors: Jr-Hong Chen, Hsinchu (TW); Gwo-Long Lin, Hsinchu (TW); Chi-Jain Wen, Hsinchu (TW)

Correspondence Address: WILDMAN, HARROLD, ALLEN & DIXON, 225 WEST WACKER DRIVE, CHICAGO, IL, 60606, US

(21) Appl. No.: 10/458,986

(22) Filed: Jun. 11, 2003

(30) Foreign Application Priority Data
Jun. 13, 2002 (TW) 91112950

(51) Int. Cl. G02F 1/1335

(52) U.S. Cl. 349/113; 349/114

(57) ABSTRACT

A transmission-reflection switch plate made of polymer dispersed liquid crystal (PDLC) and/or related materials is used as an element of a transmission-reflection switch liquid crystal display.

### BACKGROUND OF THE INVENTION

1. Field of Invention

The present invention relates to a liquid crystal display (LCD). More particularly, the present invention relates to a transmission-reflection switch liquid crystal display.

2. Description of Related Art

Liquid crystal display (LCD) has many advantages over other conventional types of displays including high picture quality, small volume occupation, light weight, low voltage drive and low power consumption. Hence, LCD is widely used in small portable televisions, mobile telephones, video recording units, notebook computers, desktop monitors, projector televisions and so on. LCD is gradually replacing conventional cathode ray tube (CRT) as a mainstream display unit.

In the beginning of the progress of LCD, transmitted LCD has been the main development axis. Generally, the light source, called a back light, of a transmitted LCD is located behind the display. Hence, the material used for the pixel electrodes has to be a transparent conductive material such as indium tin oxide (ITO). The back light of a transmitted LCD is the most power-consuming part. However, the widest application of LCD is portable computers and communication products. Electric cells are the main power supply during use. Therefore, how to decrease the power consumption of LCD is a main direction in LCD product development.

Reflective LCD is a solution to the problem mentioned above. The light source of a reflective LCD is located outside the LCD, and the light source can be a natural or artificial light source. Therefore, the material used for the pixel electrodes has to be a reflective conductive material such as metal aluminum. For achieving a better reflective result, the surface of the pixel electrodes is uneven. After the white light penetrates the liquid crystal (LC) layer, difference light paths are generated. Moreover, the travel speed of light is varied as the frequency of light varies. Hence, white light is colored after passing through the LC layer, and the color of images displayed is also affected. The top and bottom plates of the LCD are respectively allocated an alignment film to control the alignment direction of LC molecules to solve the colored problem of the white light. However, there is still an unsolved problem of the reflective LCD. That is, when the intensity of light from the outside light source is not strong enough, the reflective LCD cannot display a clear image. Therefore, the transreflective LCD has become the next target of research and development.

The pixel electrodes of some transreflective LCDs are aluminum plates having at least one opening filled with ITO. Thus, when outside light intensity is not strong enough, the back light can be turned on to serve as a light source. However, the area that can be used for display images is reduced both for transmissive and reflective mode of a transreflective LCD. That is, the open ratio of both transmissive and reflective mode for a transreflective LCD is decreased.

Polymer dispersed liquid crystal (PDLC) has been applied in electric window blinds for a long time. The window blind is cloudy white when the electricity is off, and it becomes transparent when the electricity is on.

PDLC is a photoelectric material. The method of producing PDLC is to blend monomers or oligomers with less than 5-10 wt. % LC molecules, and then conducting a polymerization reaction of monomers or oligomers to form polymer. Due to phase separation, LC molecules aggregate to form microdroplets dispersed in the matrix made by the polymer. If the content of the polymer is less than 5-10 wt. %, the mixture of LC molecules and polymer is called polymer stabilized liquid crystal (PSLC).

Besides serving as the matrix in PDLC, the refractive index of the polymer in PDLC can also affect the optical properties of PDLC. Moreover, different LC molecules of PDLC can make the PDLC have different optical properties. Generally speaking, LC molecules have a characteristic called birefringence; i.e. the refractive indexes along the directions of parallel or perpendicular to the long molecular axis of a LC molecule are different. The dielectric constants of the LC molecules also have similar characteristic. Therefore, different kinds of LC molecules can be chosen for different uses.

### SUMMARY OF THE INVENTION

It is therefore an objective of the present invention to provide a transmission-reflection switch LCD to increase the open ratio of both the transmitted mode and the reflective mode and thus the quality of the image displayed on the LCD.

It is another objective of the present invention to provide a transmission-reflection switch LCD to reduce the power consumption.

In accordance with the foregoing and other objectives of the present invention, a transmission-reflection switch liquid crystal display is provided. The transmission-reflection switch liquid crystal display comprises a first transparent substrate having a control circuit thereon. A control electrode layer, a transmission-reflection switch plate, a pixel electrode layer, a liquid crystal layer, a common electrode layer, a color filter layer, and a second transparent substrate are sequentially located on the control circuit. In the foregoing, the pixel electrode layer comprises a plurality of pixel electrodes. The material of the transmission-reflection switch plate can be polymer dispersed liquid crystal or polymer dispersed liquid crystal and metal powder.

In accordance with the foregoing and other objectives of the present invention, another transmission-reflection switch liquid crystal display is provided. The transmission-reflection switch liquid crystal display comprises a first transparent substrate having a control circuit thereon. A pixel electrode layer, a transmission-reflection switch plate, a liquid crystal layer, a common electrode layer, a color filter layer, and a second transparent substrate are sequentially located on the control circuit. The pixel electrode layer comprises a plurality of pixel electrodes. The material of the transmission-reflection switch plate can be polymer dispersed metal powder.

In accordance with the foregoing and other objectives of the present invention, a third transmission-reflection switch liquid crystal display is provided. The transmission-reflection switch liquid crystal display comprises a first transparent substrate having a control circuit thereon. A control electrode layer, a color transmission-reflection switch plate, a pixel electrode layer, a liquid crystal layer, a common electrode layer, and a second transparent substrate are sequentially located on the control circuit. In the foregoing, the pixel electrode layer comprises a plurality of pixel electrodes. The material of the color transmission-reflection switch plate can be polymer dispersed liquid crystal, and the polymer is a color photoresist used for a color filter. Hence, the color filter and the transmission-reflection switch plate are combined into one plate.

In conclusion, the invention allows the polymer dispersed liquid crystal (PDLC) and its related materials to be used as the material of a transmission-reflection switch plate. The corporation of the pixel electrodes and the control electrodes can be used to make use the whole area of the pixel electrode to be a light penetrable or light reflective area to increase the open ratio of the LCD. Polymer dispersed metal powder is used to increase the light reflectivity of the transmission-reflection switch plate. Moreover, since the material of the color filter is a polymer, the color filter and the transmission-reflection switch plate can be combined together.

It is to be understood that both the foregoing general description and the following detailed description are examples only, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1A-1B are schematic, cross-sectional views of a transmission-reflection switch LCD according to a first preferred embodiment of this invention;

FIG. 2 is a schematic, cross-sectional view of a transmission-reflection switch LCD according to a second preferred embodiment of this invention;

FIGS. 3A-3B are schematic, cross-sectional views of a transmission-reflection switch LCD according to a third preferred embodiment of this invention; and

FIGS. 4A-4B are schematic, cross-sectional views of a transmission-reflection switch LCD according to a fourth preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Generally, without applying electric field, the directions of the LC molecules of PDLC are randomized. Hence the incident light is scattered by the LC molecules in PDLC. With applied electric field, the direction with larger dielectric constant of the LC molecule aligns with the direction of the electric field to let at least 90% of light penetrate the PDLC. Therefore, the invention utilizes this characteristic of PDLC to create an optical device.

Embodiment 1:

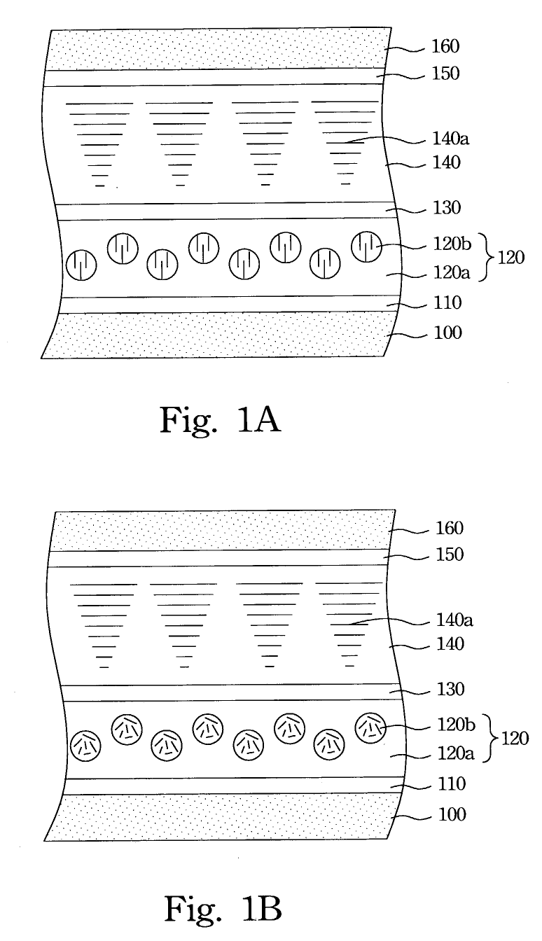

In FIGS. 1A-1B, schematic, cross-sectional views of a transmission-reflection switch LCD according to a first preferred embodiment of this invention are shown. In FIGS. 1A and 1B, a control electrode layer 110, a transmission-reflection switch layer 120, a pixel electrode layer 130, a liquid crystal layer 140, a common electrode layer 150, and a color filter plate 160 are sequentially located on a control circuit plate 100.

In the foregoing, the control circuit on the control circuit plate 100 can be active type or passive type. The transmission-reflection switch plate 120 is made of polymer dispersed liquid crystal (PDLC), which comprises polymer 120a and liquid crystal sphere 120b dispersed therein. The pixel electrode layer 130 comprises an array of pixel electrodes to control the brightness and color of each pixel. The pixel electrode layer 130 and the control electrode layer 110 cooperate to control whether the light can penetrate the transmission-reflection switch plate 120 or not. The pixel electrode layer 130 and the common electrode layer 150 control the arrangement of the liquid crystal molecules 140a of the liquid crystal layer 140. The control electrode layer 110, the pixel electrode layer 130 and the common electrode layer 150 are made of transparent conductive material such as indium tin oxide (ITO), tin oxide or conductive polymer.

Since the transmission-reflection switch plate 120 is made of PDLC, the size of the liquid crystal spheres 120b can be adjusted to control the light scattering effect. Moreover, the refractive index of the liquid crystal spheres 120b and the polymer 120a can be adjusted to make the light scattering effect of the transmission-reflection switch plate similar to a white paper. Therefore, the intensity of the reflective light is uniformly distributed when the transmission-reflection switch LCD is used in the reflective mode.

Generally speaking, when an electric field is applied to the transmission-reflection switch plate 120, the liquid crystal molecules (shown as short lines in the liquid crystal sphere 120b in FIG. 1A) in the liquid crystal sphere 120b arrange along the direction of the electric field to become light-penetrable. This is in the transmissive mode. In this transmissive mode, a back light can be used as a light source. When no electric field is applied to the transmission-reflection switch plate, the liquid crystal molecules (shown as short lines in the liquid crystal sphere 120b in FIG. 1B) in the liquid crystal sphere 120b arrange randomly to become light-scattering. This is in the reflective mode. In this reflective mode, a light source located outside the transmission-reflection switch LCD is used to display images.

Embodiment 2:

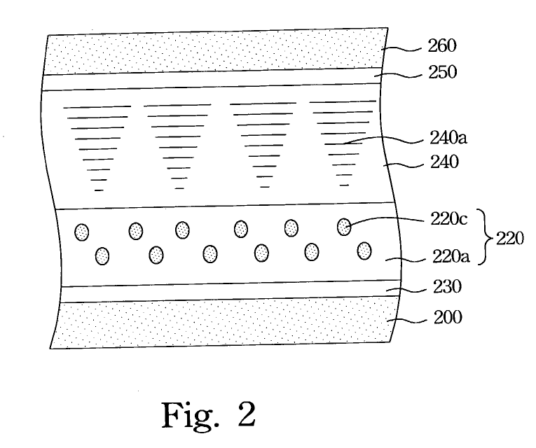

In FIG. 2, a schematic, cross-sectional view of a transmission-reflection switch LCD according to a second preferred embodiment of this invention is shown. A pixel electrode layer 230, a transmission-reflection switch layer 220, a liquid crystal layer 240, a common electrode layer 250, and a color filter plate 260 are sequentially located on a control circuit plate 200.

In the foregoing, the control circuit on the control circuit plate 200 can be active type or passive type. The pixel electrode layer 230 comprises an array of pixel electrodes to control the brightness and color of each pixel. The transmission-reflection switch plate 220 is made of polymer 220a dispersed metal powder 220c. The arrangement of the liquid crystal molecules 240a is controlled by the pixel electrode layers 230 and the common electrode layer 250. The pixel electrode layer 230 and the common electrode layer 250 are made of transparent conductive material such as ITO, tin oxide or conductive polymer.

The concentration of metal powder 220c in the transmission-reflection switch plate 220 needs to be controlled within a suitable range. Therefore, the light from the back light can penetrate the polymer 220a of the transmission-reflection switch plate 220 and the light from the outside light source can be scattered back by the metal powder 220c. Consequently, when the light intensity from outside is strong enough, the transmission-reflection switch plate 220 can serve as a reflective plate for the light outside. When the light intensity from outside is not strong enough, the transmission-reflection switch plate 220 can allow the light from the back light to penetrate it.

Embodiment 3;

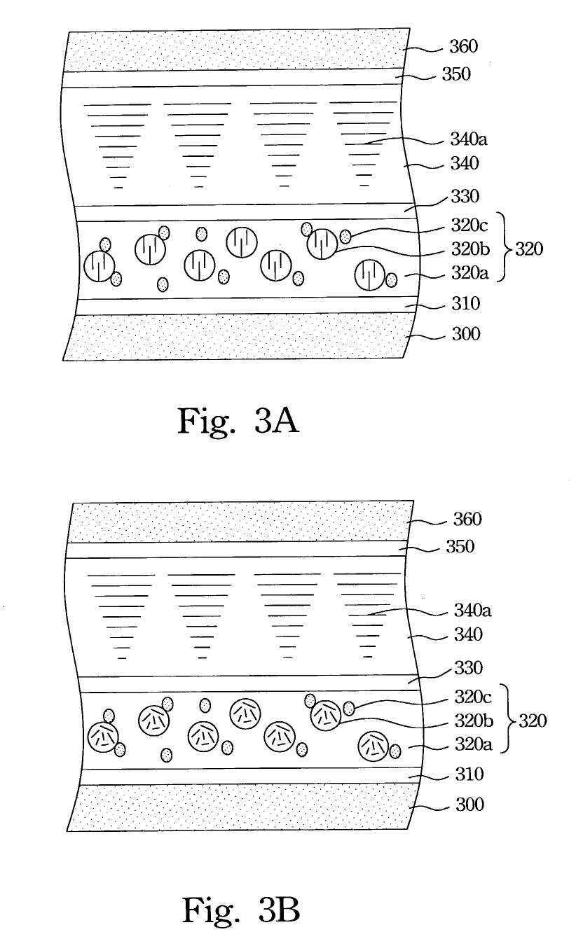

In FIGS. 3A-3B, schematic, cross-sectional views of a transmission-reflection switch LCD according to a third preferred embodiment of this invention are shown. A control electrode layer 310, a transmission-reflection switch layer 320, a pixel electrode layer 330, a liquid crystal layer 340, a common electrode layer 350, and a color filter plate 360 are sequentially located on a control circuit plate 300.

In the foregoing, the control circuit on the control circuit plate 300 can be active type or passive type. The transmission-reflection switch plate 320 is made of PDLC, which comprises polymer 320a and liquid crystal sphere 320b and metal powder 320c dispersed therein. The pixel electrode layer 330 comprises an array of pixel electrodes to control the brightness and color of each pixel. The pixel electrode layer 330 and the control electrode layer 310 cooperate to control whether the light can penetrate the transmission-reflection switch plate 320 or not. The pixel electrode layer 330 and the common electrode layer 350 control the arrangement of the liquid crystal molecules 340a of the liquid crystal layer 340. The control electrode layer 310, the pixel electrode layer 330 and the common electrode layer 350 are made of transparent conductive material such as ITO, tin oxide or conductive polymer.

Embodiment 3 adds metal powder 320c in the transmission-reflection switch plate 120 in FIGS. 1A-1B to enhance the light reflectivity of the transmission-reflection switch plate 320 in FIGS. 3A-3B. The concentration of the metal powder 320c still has to be carefully controlled in a suitable range. Therefore, when an electric field is applied on the transmission-reflection switch plate 320, the light from the back light can penetrate the transmission-reflection switch plate 320 through portions between metal powder 320c.

Embodiment 4:

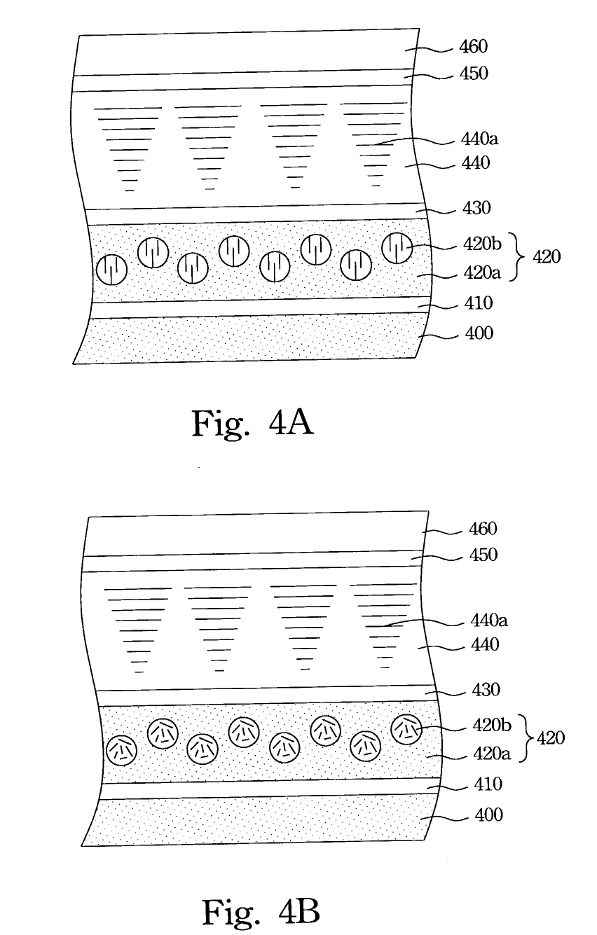

In FIGS. 4A-4B, schematic, cross-sectional views of a transmission-reflection switch LCD according to a fourth preferred embodiment of this invention are shown. A control electrode layer 410, a color transmission-reflection switch layer 420, a pixel electrode layer 430, a liquid crystal layer 440, a common electrode layer 450, and a transparent plate 460 are sequentially located on a control circuit plate 400.

In the foregoing, the control circuit on the control circuit plate 400 can be active type or passive type. The color transmission-reflection switch plate 420 is made of color PDLC, which comprises color polymer 420a and liquid crystal sphere 420b dispersed therein. The material of color polymer 420a is generally the same as that used for color filter. The pixel electrode layer 430 comprises an array of pixel electrodes to control the brightness and color of each pixel. The pixel electrode layer 430 and the control electrode layer 410 cooperate to control whether the light can penetrate the color transmission-reflection switch plate 420 or not. The pixel electrode layer 430 and the common electrode layer 450 control the arrangement of the liquid crystal molecules 440a of the liquid crystal layer 440. The control electrode layer 410, the pixel electrode layer 430 and the common electrode layer 450 are made of transparent conductive material such as ITO, tin oxide or conductive polymer.

Since the material used for the color filter is a color photoresist, which is also a polymer, the color polymer 420a of the color transmission-reflection switch plate 420 can adopt this kind of color photoresist. Consequently, the color filter and the transmission-reflection switch plate are combined into one plate.

From the preferred embodiments described above, it can be seen that the transmission-reflection switch plate uses a polymer to be a matrix and the liquid crystal and/or the metal powder dispersed in the polymer. An electric field is applied on the transmission-reflection switch plate to control the arrangement direction of the liquid crystal molecules to determine whether the light can penetrate the transmission-reflection switch plate or not. Although the metal powder is used to enhance the reflectivity of the transmission-reflection switch plate, the concentration of the metal powder needs to be controlled in a suitable range to let the light penetrate the transmission-reflection switch plate. Finally, the polymer of the transmission-reflection switch plate adopts the color photoresist to combine the color filter and the transmission-reflection switch plate.

For the conventional transreflective LCD, a portion of the pixel area uses a metal electrode as a light reflective plate, and a portion of the pixel area uses ITO electrode to be a light penetrable plate. Unlike the conventional transreflective LCD, this invention utilizes the whole pixel area as a light reflective plate or a light penetrable plate. Therefore, this invention can increase the open ratio of each pixel and thus the quality of the image displayed on the LCD.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A transmission-reflection switch liquid crystal display, comprising:
a first transparent substrate having a control circuit on its first surface;
a control electrode layer on the first surface;
a transmission-reflection switch plate on the control electrode layer;
a pixel electrode layer comprising a plurality of pixel electrodes on the transmission-reflection switch plate, the pixel electrode layer and the control electrode layer cooperate to control the light reflective percentage of the transmission-reflection switch plate;
a liquid crystal layer on the pixel electrode layer;
a common electrode layer on the liquid crystal layer; and
a second transparent substrate on the common electrode layer.

2. The transmission-reflection switch liquid crystal display of claim 1, wherein a material of the transmission-reflection switch plate includes polymer dispersed liquid crystal.

3. The transmission-reflection switch liquid crystal display of claim 1, wherein a material of the transmission-reflection switch plate includes polymer dispersed liquid crystal and metal powder.

4. The transmission-reflection switch liquid crystal display of claim 1, wherein a material of the transmission-reflection switch plate includes color polymer dispersed liquid crystal.

5. The transmission-reflection switch liquid crystal display of claim 1, wherein the control circuit is an active control circuit.

6. The transmission-reflection switch liquid crystal display of claim 1, wherein the control circuit is a passive control circuit.

7. The transmission-reflection switch liquid crystal display of claim 1, wherein a material of the control electrode layer, the pixel electrode layer and the common electrode layer is a transparent conductive material.

8. The transmission-reflection switch liquid crystal display of claim 7, wherein the transparent conductive material comprises indium tin oxide, tin oxide or a conductive polymer.

9. The transmission-reflection switch liquid crystal display of claim 1, further comprising a color filter layer between the common electrode layer and the second transparent substrate.

10. A transmission-reflection switch liquid crystal display, comprising:
a first transparent substrate having a control circuit on its first surface;
a pixel electrode layer on the first surface, the pixel electrode layer comprising a plurality of pixel electrodes;
a transmission-reflection switch plate on the pixel electrode layer;
a liquid crystal layer on the transmission-reflection switch plate;
a common electrode layer on the liquid crystal layer; and
a second transparent substrate on the color filter.

11. The transmission-reflection switch liquid crystal display of claim 10, wherein a material of the transmission-reflection switch plate includes polymer dispersed metal powder.

12. The transmission-reflection switch liquid crystal display of claim 10, wherein the control circuit is an active control circuit.

13. The transmission-reflection switch liquid crystal display of claim 10, wherein the control circuit is a passive control circuit.

14. The transmission-reflection switch liquid crystal display of claim 10, wherein a material of the pixel electrode layer and the common electrode layer is a transparent conductive material.

15. The transmission-reflection switch liquid crystal display of claim 14, wherein the transparent conductive material comprises indium tin oxide, tin oxide or a conductive polymer.

16. The transmission-reflection switch liquid crystal display of claim 10, further comprising a color filter layer between the common electrode layer and the second transparent substrate.
